(19) United States
(12) Patent Application Publication
(10) Pub. No.: US 2020/0346957 A1
(43) Pub. Date: Nov. 5, 2020

(54) BIOFILM DISRUPTION LEADING TO MICROBIAL DESTRUCTION

(71) Applicant: DRIPPING WET WATER, INC., San Antonio, TX (US)

(72) Inventors: Richard SAMPSON, San Antonio, TX (US); Allison SAMPSON, San Antonio, TX (US); James Andrew MIALKOWSKI, San Antonio, TX (US); Mauricio Mata NIETO, San Antonio, TX (US)

(73) Assignee: DRIPPING WET WATER, INC., San Antonio, TX (US)

(21) Appl. No.: 16/859,170

(22) Filed: Apr. 27, 2020

Related U.S. Application Data
(60) Provisional application No. 62/842,090, filed on May 2, 2019.

(51) Int. Cl. C02F 3/10; A01N 59/00; C01B 11/02

(52) U.S. Cl. CPC C02F 3/102; C01B 11/024; A01N 59/00

(57) ABSTRACT

A method of treating biofilm having a protective extracellular polymeric substance (EPS) membrane attached to a surface applies chlorine dioxide to the biofilm attached a surface to disrupt the EPS membrane of the biofilm and thereby expose microbes in the biofilm to microbicide attack and death without detaching the biofilm from the surface.

### FIELD OF THE INVENTION

The present invention relates to the treatment of biofilms, attached to both animate and inanimate surfaces, in both aqueous and nonaqueous environments. In particular, the present invention concerns the treatment of biofilms in order to disrupt the protective extracellular polymeric substance and expose the microbes living in the biofilm for destruction.

### BACKGROUND OF THE INVENTION

Microorganisms (aka “microbial cells” and “microbes”) exist in both aqueous and nonaqueous environments. These microorganisms can then attach to adjacent surfaces and self-produce extracellular polymeric substance (EPS) to form what is known as a biofilm, i.e., a community of microbial cells enclosed in matrix of the self-produced EPS. The EPS matrix or membrane of the biofilm protects the microbial colony enclosed therein from microbicide attack. As illustrated in FIG. 1, biofilm formation does not begin until there is an attachment of a microorganism to an animate or inanimate surface. Surface attachment is, in fact, by definition required for a “biofilm” to exist. The surface can be on anything from the inside of a liquid-transporting pipe to the inside of a lung (human and animal).

The biofilm EPS membrane acts like a shield to protect a microbial colony within the biofilm. The EPS membrane is made up of sugars (polysaccharides), proteins, and nucleic acid (DNA, RNA). The EPS membrane forms a protective matrix, i.e., in effect a network of protective tunnels, within which the microorganisms live, thrive, multiply, and continually expand the EPS matrix structure. The microbes and their colonies start, grow, complete, and expand biofilm formation mostly through quorum sensing, recruitment, and mutation.

Once formed, biofilm will continue to grow and spread along the surface to which it is attached. The growing biofilm will spread as long as the EPS membrane is intact.

Biofilms and their study are currently especially important to the medical and public health fields, in particular with respect to biofilm involvement in the appearance of drug-resistant, pathological microbes, such as described in, e.g., the following publications: Rinaldi, A., “Biofilms in cystic fibrosis,” The Scientist Magazine, available online at URL: https://www.the-scientist.com/research-round-up/biofilms-in-cyctic-fibrosis-51512 (Rinaldi), Richtel, M., et a., “A Mysterious Infection: Spanning the Globe in a Climate of Secrecy,” available online at URL: https://www.nytimes.com/2019/04/06/health/drug-resistant-candida-auris.html (Richtel), Sherry, L., et al., “Biofilm-Forming Capability of Highly Virulent, Multidrug-Resistant Candida auris,” Emerging Infectious Diseases, 23, 328-331 (2017) (Sherry), and Stewart, P. S., et al., “Prospects for Anti-Biofilm Pharmaceuticals,” Pharmaceuticals (Basel), 8, 504-511 (2015), Published online 2015 Aug. 27, doi: 10.3390/ph8030504 (Stewart); the disclosures of which publications are incorporated by reference as fully set forth herein.

Biofilms and their study are also currently important in the water-treatment industry. For many years, traditional microbicides have been used in the water treatment industry to kill free-floating microorganisms in the water, La., to prevent the free-floating microorganisms from attaching to, and forming a biofilm on, a water carrying surface. For example, a microbicide (e.g., oxidizing microbicides such as chlorine and bromine) is typically continuously dosed into a water stream so that there is a continuous killing of free-floating microorganisms therein, and agents (e.g., chlorine dioxide) have been dosed into a water stream continuously flowing over a biofilm contaminated surface in order to detach the biofilm from the contaminated surface and carry the detached remnant away in the continuously flowing water stream; thus keeping the surface in contact with the water stream in the treatment system continuously clean (i.e., biofilm free). There are, however, cases, both in aqueous and nonaqueous environments and with respect to animate and inanimate biofilm contaminated surfaces, where it is impractical to detach the biofilm from a contaminated surface (i.e., the surface to which the biofilm is attached).

In an attempt to kill the microorganisms within biofilm, microbicides have been applied to the biofilm. However, biofilm has a charged surface, which repels the applied microbicides, rendering them ineffective in killing microorganisms encased within the biofilm (i.e., within the biofilm EPS protective matrix). This circumstance means that, despite the known treatment of biofilm contaminated surfaces with microbicides, the microorganisms living within the biofilm will continue to grow and proliferate. The removal (i.e., cleaning) of biofilm from a surface in the water treatment industry has been accomplished in the past by adding chlorine dioxide to the water streaming over the biofilm contaminated surface.

Thus, there still remains a need, in particular in the medical and public health fields, for a way to destroy microbes protected in biofilm.

### SUMMARY OF THE INVENTION

In the present invention the biofilm EPS membrane acts like a gas permeable membrane protecting the microorganisms of the biofilm. Since the biofilm EPS membrane is highly resistant to oxidation, strong oxidizers such as, but not limited to, chlorine and bromine do not disrupt the biofilm EPS membrane structure. Therefore, it was surprising to find that in accordance with the present invention increased concentration of chlorine dioxide, a weak oxidizer, disrupts the biofilm EPS membrane, when strong oxidizers such as, chlorine and bromine do not.

Accordingly, the present invention provides a method of treating a biofilm which comprises applying chlorine dioxide to the biofilm in order to disrupt the protective EPS membrane and expose the microbes within the biofilm to a microbicide attack and potential death. The microbicide is preferably applied to the biofilm, simultaneously with or subsequently to applying the chlorine dioxide, thereby killing the exposed microbes.

In accordance with the present invention, the EPS membrane of the biofilm is disrupted and microbes therein are thus subject to destruction and killed. Also in accordance with the present invention, disruption of the biofilm EPS membrane, with the microbes therein killed, can occur in an aqueous or non-aqueous environment.

### BRIEF DESCRIPTION OF THE DRAWINGS

FIG. 1 schematically illustrates the formation of biofilm on a surface.

FIG. 2 schematically illustrates biofilm disruption and microbe destruction according to the present invention.

FIGS. 3A, 3B, 3C, and 3D are photographs that show the progression of an infected cut at 0 hours, 12 hours, 24 hours, and 36 hours, respectively.

FIGS. 4A, 4B, 4C, and 4D are photographs that show the progression of an infected cut at 0 hours, 12 hours, 24 hours, and 36 hours, respectively.

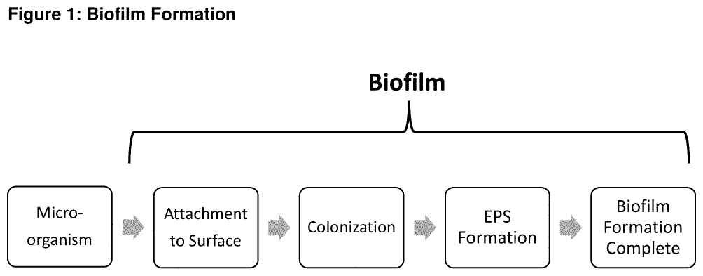

### FURTHER DESCRIPTION OF THE INVENTION

As used herein the following terms will have the meanings stated. The term “disrupt biofilm” or “biofilm disruption” means fissuring (breaking down) the protective and connective EPS matrix structure of the biofilm and exposing the microorganisms living inside the biofilm. The term “microbicide” or “antimicrobial” means an agent that specifically destroys or prevents the growth of microbiological species. Examples of microbicides include, but are not limited to, antibiotics, antivirals, and antifungals. The term “aqueous environment” means an environment that is primarily or completely made up of water. The term “nonaqueous environment” refers to an environment that is primarily or completely made up of a liquid other than water or a gas. The term “animate surface” means a surface, internal or external, of a living organism. The term “inanimate surface” means a surface of nonliving matter.

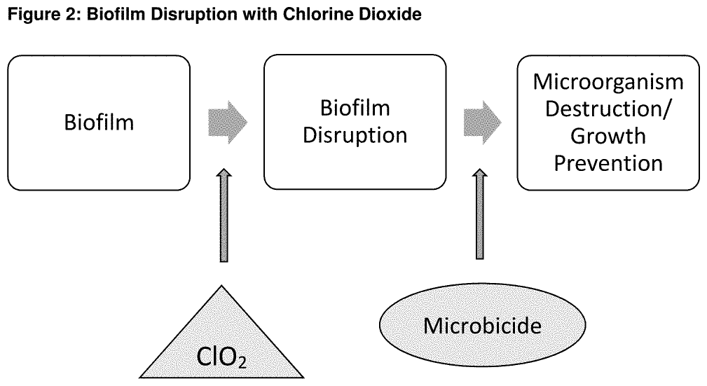

The present invention relates to the use of chlorine dioxide to disrupt the EPS membrane of the biofilm. Chlorine dioxide, as explained above, has been used to remove biofilm from inanimate surfaces, and chlorine dioxide is also a known microbicide. However, as also explained above, microbicides that have been applied to biofilm are ineffective at killing microorganisms that exist within the biofilm due to the presence of the EPS membrane. Also, strong oxidizers have been ineffective at disrupting the EPS membrane of the biofilm. The present invention, as opposed to the prior art, applies chlorine dioxide in a manner that contacts and disrupts the EPS membrane of the biofilm. More precisely, application of the chlorine dioxide according to the present invention contacts and breaks down the microorganism protecting EPS matrix, thereby exposing the microorganisms to attack from a secondarily applied microbicide as is shown in FIG. 2.

Biosecurity is a set of preventive measures designed to reduce the risk of transmission of infectious diseases. The combination of disrupting biofilm with chlorine dioxide and attacking the microbes exposed by the disruption with microbicides in accordance with the present invention is biosecurity for animate and inanimate surfaces within aqueous or nonaqueous environments.

In accordance with the present invention chlorine dioxide (chemical formula ClO₂), in aqueous and non-aqueous environments, is applied to the biofilm either as dissolved in aqueous solution (as used herein “aqueous chlorine dioxide” and “aqueous chlorine dioxide solution” are used synonymously) or as gaseous chlorine dioxide. The concentration of chlorine dioxide necessary to disrupt biofilm in accordance with the present invention is generally about 0.05 to about 3,000 mg/I, and preferably is dosed until there is a residual in the aqueous stream of approximately 0.05 to 300 mg/I. In order to keep the chlorine dioxide from decomposing, the chlorine dioxide is maintained with a pH range of about 1 to about 10. Preferably, the pH of the chlorine dioxide would not affect the environment. The chlorine dioxide also must remain in contact with the biofilm for a sufficient time to disrupt the biofilm EPS membrane enough to expose the microbes therein to microbicide attack and death. The time required varies with the biofilm environment and surface on which the biofilm is attached. However, the applied chlorine dioxide, is allowed to remain in contact with the biofilm until a residual of approximately 9/10 of the original dose concentration is achieved.

The particular microbicide, or microbicides, used in a given instance will depend upon the particular microbes expected to be exposed upon disruption of their protective EPS matrix. Particular microbicides, and their amounts, needed to kill particular microbes exposed by biofilm disruption, in accordance with present invention, will be known to, or readily determined by, the person of ordinary skill in the art. In particular, for killing microbes exposed by biofilm disruption on biofilm on internal surfaces of the human body (e.g., the surface of the lung), the particular microbicides (e.g., antibiotic, antifungal, etc.), the particular dosage administered, and the mode of administration, in accordance with the present invention, will be well known to, or readily determined by, the person of ordinary skill in the art.

### EXAMPLES

The following examples have not been completed but provide exemplary applications to demonstrate the present invention.

### Example 1

Humidifier with Chlorine Dioxide and Microbicide

Chlorine dioxide in this example has dual functionality. It disrupts the biofilm EPS membrane and kills the microorganisms within. A dilute solution of aqueous chlorine dioxide at a concentration of less than or equal to 3,000 mg/I fills the reservoir inside a humidifier, and the humidifier is then placed in a room (non-aqueous environment) that contains biofilm-contaminated (inanimate) surfaces and run. The humidifier produces aerosol droplets of aqueous chlorine dioxide such that the droplets contact, and so disrupt, the biofilm EPS membrane on all the surfaces of the room, leaving the microbes present in the biofilm exposed (i.e., unprotected). A portion of the chlorine dioxide will off-gas from the aqueous solution as the droplets are aerosolized. The aqueous chlorine dioxide is aerosolized in the room such that the chlorine dioxide residual in the air of the room does not exceed the OSHA Permissible Exposure Limit (PEL) for chlorine dioxide at 0.1 ppm over 8 hours. The produced aerosol droplets of chlorine dioxide disrupt the biofilm EPS membrane and kill the exposed microorganisms in the biofilm, rendering the surfaces in the room biosecure.

### Example 2

Chlorine Dioxide on a Bandage to Treat an Abrasion

Aqueous chlorine dioxide at a concentration less than or equal to 1,000 mg/I is applied to a bandage. The bandage is directly applied to a biofilm-contaminated skin abrasion (animate surface) such that the chlorine dioxide in the bandage contacts and disrupts the biofilm EPS membrane on the abrasion, thereby exposing microorganisms in the biofilm to killer cells of the body's immune system to kill the microorganisms.

### Example 3

Chlorine Dioxide to Treat a Lung Infection

Gaseous chlorine dioxide mixed with oxygen is administered through a nasal cannula to a patient with a lung infection. The chlorine dioxide contacts and disrupts the biofilm EPS membrane attached to the internal surfaces of the lung, thereby exposing bacteria in the biofilm to antimicrobial attack. The patient is also given oral antibiotics, shortly before administering the gaseous chlorine dioxide, which antibiotics are then in the patient's bloodstream to attack and kill the exposed microbes in the biofilm.

### Example 4

Chlorine Dioxide Disrupts Biofilm within an Infected Cut

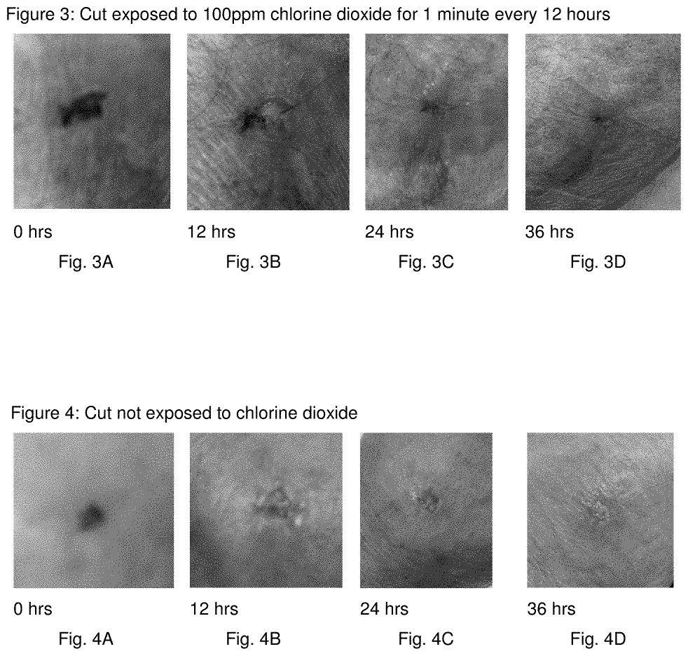

Chlorine Dioxide and CURAD Antibacterial Bandages (benzalkonium chloride) are used in this example. The first of two infected cuts is exposed to 100 ppm of chlorine dioxide for 1 minute before the benzalkonium chloride bandage is applied. The second infected cut is not exposed to chlorine dioxide before the benzalkonium chloride bandage is applied. Both cuts are retreated every 12 hours. FIG. 3 shows the progress of the infected cut treated with chlorine dioxide. FIG. 4 shows the progress of the infected cut without being treated with chlorine dioxide. FIG. 3 illustrates that after 36 hours the first cut's infection, treated with chlorine dioxide, is significantly reduced. FIG. 4 illustrates that after 36 hours the second cut's infection, not treated with chlorine dioxide, actually increases. Comparison of the results shows that (1) benzalkonium chloride (antibiotic) in the bandage significantly reduces the first cut's infection because the chlorine dioxide disrupts the biofilm EPS membrane, thereby exposing microbes in the biofilm to the benzalkonium chloride, and (2) benzalkonium chloride in the bandage has no apparent effect on the second cut's infection, because the benzalkonium chloride cannot penetrate the biofilm EPS membrane, actually resulting in an increase of infection, as can be seen by the increase in redness encircling the cut.

What is claimed is:

1. A method of treating biofilm having a protective extracellular polymeric substance (EPS) membrane attached to a surface comprising applying chlorine dioxide to the biofilm attached a surface to disrupt the EPS membrane of the biofilm and thereby expose microbes in the biofilm to microbicide attack and death without detaching the biofilm from the surface.

2. The method of claim 1 wherein the biofilm is attached to an inanimate surface.

3. The method of claim 1 wherein the biofilm is attached to an animate surface.

4. The method of claim 1 further comprising applying at least one microbicide to the exposed microbes, thereby, killing the exposed microbes.

5. The method of claim 4, wherein the at least one microbicide is chlorine dioxide in water at a pH of about 1 to about 10.

6. The method of claim 4, wherein the at least one microbicide is selected from the group consisting of an antibiotic, an antiviral, an antifungal, and combinations thereof.

7. The method of claim 1 further comprising applying the chlorine dioxide combined with at least one microbicide to the biofilm such that the microbicide kills the exposed microbes.

8. The method of claim 7, wherein the at least one microbicide is chlorine dioxide in water at a pH of about 1 to about 10.

9. The method of claim 7, wherein the at least one microbicide is selected from the group consisting of an antibiotic, an antiviral, an antifungal, and combinations thereof.

10. The method of claim 1, wherein the chlorine dioxide is applied to an aqueous environment.

11. The method of claim 1, wherein the chlorine dioxide is applied to a non-aqueous environment.

12. The method of claim 10, wherein the application is biosecurity for said aqueous environment.

13. The method of claim 11, wherein the application is biosecurity for said non-aqueous environment.
